(19) United States
(12) Patent Application Publication
(10) Pub. No.: US 2009/0149166 A1
(43) Pub. Date: Jun. 11, 2009

(54) METHOD, SYSTEM AND APPARATUS FOR CONVEYING AN EVENT REMINDER

(76) Inventors: Hakem Mohamedali Habib, Oshawa (CA); Nawal Nawas, Toronto (CA); David William Clark, Carp (CA); Stephane Maxime Francois Fortier, Breakeyville (CA)

Correspondence Address: SMART & BIGGAR, 1000 DE LA GAUCHETIERE ST. W., SUITE 3300, MONTREAL, QC, H3B 4W5, CA

(21) Appl. No.: 11/997,365

(22) PCT Filed: Apr. 24, 2006
(86) PCT No.: PCT/CA2006/000648

§ 371 Date: Jan. 30, 2008

(51) Int. Cl. H04W 4/00; G04B 47/00; H04M 3/42

(52) U.S. Cl. 455/414.3; 368/10; 379/207.02; 379/207.13

(57) ABSTRACT

A method and system for conveying an event reminder associated with an event according to various embodiments of the invention are disclosed. Specifically, the method comprises receiving a spoken indication of an event description from a user and receiving an indication of an event time. The method further comprises storing the event description in association with the user in a memory. An event reminder time is determined based on the event description. In response to an occurrence of the event reminder time, the event reminder comprising at least the event description is conveyed to the user. The instant invention allows the user to provision an event reminder by using voice, which enables the user to employ different types of communication devices (such as legacy POTS phones, VoIP phones, wireless communication devices and the like) for establishing a reminder provisioning session with a server.

### FIELD OF THE INVENTION

This invention relates generally to telecommunications systems and more specifically to a method, system and apparatus for conveying an event reminder.

### BACKGROUND OF THE INVENTION

Computers can simplify many aspects of day-to-day work and personal life. For example, a spreadsheet application can significantly reduce the time required to put together budget calculations and a presentation application can assist in putting together effective visual aids. A communications application (such as Outlook™ or Lotus Notes™) provides means to send and receive e-mails, plan tasks, schedule appointments, as well as allow users to perform a number of other useful tasks.

As users become more sophisticated, they expect and demand complex computing functionality to be integrated into their wireless communication devices as well. To that end, several vendors of wireless communication devices have developed operating systems that would allow users of wireless communication devices to perform certain computing tasks. The complexity of the operating systems varies with the vendor. For example, a Blackberry™ device from Research In Motion of 295 Phillip Street, Waterloo, Ontario, Canada allows users to perform many functions that could traditionally be performed only by using a desktop computer or a laptop, such as send and receive e-mails, schedule appointments and enter reminders, just to name a few.

Even though existing systems provide means to manage appointments and tasks, as well as generate reminders, these systems have been primarily adopted by limited segments of the population, while other segments of the population may be unwilling or unable to make use of these existing systems. For example, a student may not be able to use the Blackberry™ device, as the service subscription costs may be prohibitive. An elderly person wishing to schedule various events (such as doctor visits, medicine taking time slots, etc.) may not use a desktop application, as he or she may not be familiar with how to use such desktop application and indeed the prospect of learning the skills required to use desktop applications in general may be formidable.

Therefore, there remains a need for a system for conveying event reminders that is easy-to-use and that would be appealing to various user segments.

### SUMMARY OF THE INVENTION

According to a first broad aspect there is provided a method for conveying an event reminder associated with an event. The method comprises: receiving a spoken indication of an event description from a user; receiving an indication of an event time; storing said event description in association with the user in a memory; determining an event reminder time based on said event time; responsive to an occurrence of said event reminder time, conveying the event reminder to the user; the event reminder comprising at least said event description.

According to a second broad aspect there is provided an apparatus for conveying an event reminder. The apparatus comprises means for receiving a spoken indication of an event description from a user; means for receiving an indication of an event time; means for storing said event description in association with the user in a memory; means for determining an event reminder time based on said event description; means for conveying the event reminder to the user; the event reminder comprising at least said event description; the means for conveying being responsive to an occurrence of said event reminder time.

According to a third broad aspect there is provided a system for conveying an event reminder. The system comprises an interactive voice entity comprising: an input operable to receive a spoken indication of an event description from the user of the communication device; and to receive an indication of an event time. The interactive voice entity further comprises a memory operable to store said event description in association with the user in the memory; a processing entity operable to determine an event reminder time based on said event description; an output operable to convey the event reminder to the user responsive to an occurrence of said event reminder time; the event reminder comprising at least said event description.

According to another broad aspect there is provided a method for provisioning an event reminder. The method comprises establishing a reminder provisioning communication session with a server, the server being operable to execute a speech recognition function; providing a spoken indication of an event description; said spoken indication of an event description for enabling the server to store said event description; providing an event time; said event time for enabling the server to determine an event reminder time; at a time no earlier than said event reminder time, receiving the event reminder; the event reminder comprising at least said event description.

According to another broad aspect there is provided a method for handling an event reminder associated with an event. The method comprises receiving a spoken indication of an event description from a user; receiving an indication of an event time; storing said event description as an audio file attached to a time slot in a scheduling application, the time slot corresponding to said event time.

These and other aspects and features of the present invention will now become apparent to those skilled in the art upon review of the following description of specific embodiments of the invention in conjunction with the accompanying drawings.

### BRIEF DESCRIPTION OF THE DRAWINGS

Non-limiting embodiments of the present invention are described with reference to the following figures, in which:

FIG. 1 diagrammatically shows various components of a system for conveying an event reminder according to a non-limiting embodiment of the present invention;

FIG. 2 diagrammatically shows a system for conveying an event reminder according to another non-limiting embodiment of the present invention;

FIG. 3 diagrammatically shows in more detail a memory of the system of FIG. 1; and

FIG. 4 depicts a method for conveying an event reminder employing the system of FIG. 1.

It is to be expressly understood that the description and drawings are only for the purpose of illustration of certain embodiments of the invention and are an aid for understanding. They are not intended to be a definition of the limits of the invention.

### DETAILED DESCRIPTION OF EMBODIMENTS

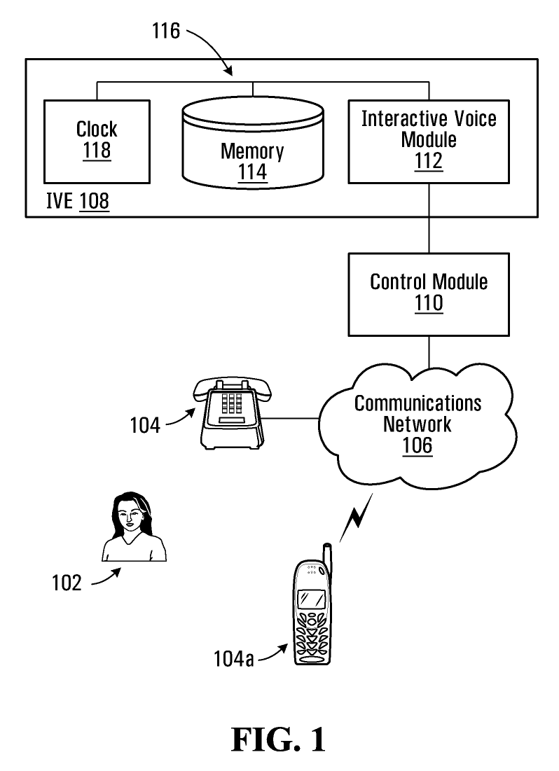

Reference is made to FIG. 1, which depicts a communication device 104 that may be employed by a user 102 to effect various communication activities, such as, but not limited to, originating an outgoing call to a called party device and answering an incoming call. By way of several non-limiting examples, the communication device 104 may be a wired Plain Old Telephone System (POTS) phone (including a cordless phone), a wireless phone (e.g. a cellular or other mobile device, including a telephony-enabled wireless personal digital assistant), a VoIP phone, a soft phone (i.e., a computer equipped with a software application for VoIP telephony), a POTS phone equipped with an Analog Telephony Adapter (ATA) and the like. The communication device 104 is associated with a network identifier, which in various embodiments of the present invention can be embodied as a telephone number, a SIP address, an IP address or any other suitable type of network identifier.

The user 102 may also have access to a communication device 104a, which may be similar to the communication device 104 and, practically speaking, can represent a POTS telephone located at a vacation property, a second cellular device, a business telephone line phone, an office telephone line phone, and the like. In the example embodiment described in FIG. 1, the communication device 104 may be a wired POTS phone and the secondary communication device 104a may be a cellular phone.

The communication device 104 is connected to a communications network 106. The type of the communications network 106 is not to be considered limiting as the communications network 106 may comprise at least a portion of at least one of the Public Switched Telephone Network (PSTN), a public data network adapted for supporting VoIP traffic, a private data network adapted for supporting VoIP traffic, a wireless network and the like. Naturally, the type of the communication device 104 will depend on the type of the communications network 106. For example, if the communications network 106 comprises a public data network adapted for supporting VoIP traffic, the communication device 104 can comprise a VoIP phone, a soft phone or a POTS phone equipped with an ATA. In the specific example depicted in FIG. 1, the communications network 106 comprises the PSTN.

There is also provided an interactive voice entity (hereinafter referred to as “IVE”) 108 coupled to the communications network 106. In some non-limiting embodiments, the IVE 108 can be connected directly to the communications network 106. This is particularly true for embodiments where the communications network 106 comprises a data network adapted for supporting VoIP traffic. In the example non-limiting embodiment depicted in FIG. 1, the IVE 108 can be coupled to the communications network 106 via a control module 110. Generally speaking, the control module 110 is operable to mediate communications between the IVE 108 and the communications network 106, such as but not limited to translating digital communication to analog communication and vice versa, obtaining Calling Line Identification (CLID) information, initiating outgoing calls, detecting and interpreting DTMF signals and the like. An example control module 110 can be embodied as a Ubiquity Application Server, which can be provided by Ubiquity of 515 Legget Drive, Suite 400, Ottawa, Ontario, Canada. It should be understood that any other suitable call processing logic can be employed for the purposes of the embodiments of the present invention, and that as one skilled in the art will appreciate, the call processing logic may depend on the type of signalling information used by the communications network 106 and the type of processing required.

The IVE 108 may be controlled and managed by a service provider that controls and manages the communications network 106. Alternatively, the IVE 108 may be controlled and managed by a third party.

In accordance with an event reminder service of the non-limiting embodiments contemplated herein, the IVE 108 is operable to convey an event reminder, as will be described in further detail herein below. To that end, the IVE 108 can comprise an interactive voice module 112, which in some embodiments may be embodied as a Nuance Voice Platform available from Nuance of 1 Wayside Road, Burlington, Mass., United States. It should be noted that any other commercially available or proprietary voice recognition hardware and/or software can be used. The interactive voice module 112 may implement several functions, as will be described herein below. For now, suffice it to say that the interactive voice module 112 is operable to implement an interactive voice response function, a speech recognition function, a text to speech function, and possibly other functions.

It should be noted that, in some non-limiting embodiments, the functionality of the interactive voice module 112 can be distributed. In other words, each of the functions or each sub-group of functions can be performed by a distinct entity (not depicted). For example, the interactive voice response function can be implemented by the control module 110, the speech recognition function can be implemented by the interactive voice module 112, etc. Those skilled in the art will appreciate that other alternatives are also possible.

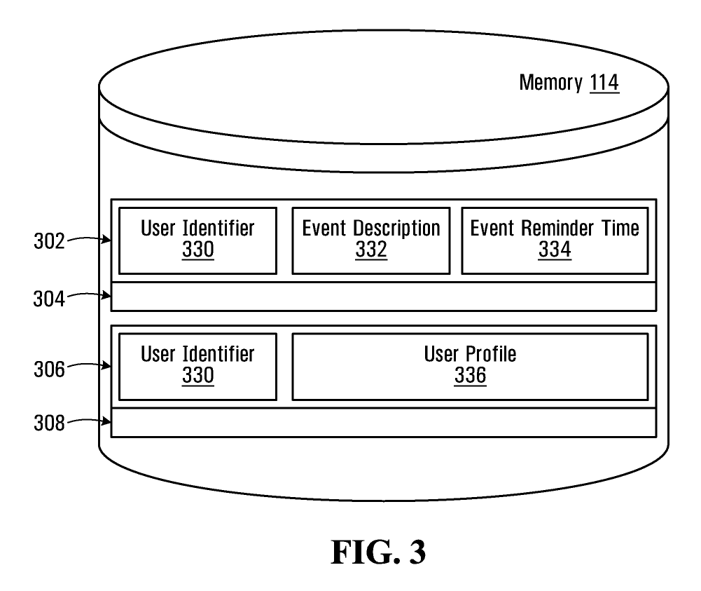

Communicatively coupled to the interactive voice module 112 is a memory 114. The memory 114 may be coupled to the interactive voice module 112 via a link 116, which can be a Local Area Network, an Ethernet connection, a wireless connection, or any other type of connection. Naturally, the memory 114 can reside at another entity (not depicted) and can be accessible by the interactive voice module 112 via a network, such as the Internet, a private data network and the like. With reference to FIG. 3, which depicts an example non-limiting embodiment of the memory 114, the memory 114 can be implemented in any type of suitable memory, such as a random access memory and the like. In some non-limiting embodiments of the present invention, the memory 114 can be implemented in a commercially available calendar application. Some non-limiting examples of the commercially available calendar applications include Microsoft® Outlook®, Lotus Notes® and the like. Naturally, the memory 114 can be implemented in a proprietary calendar application or any other suitable type of memory.

The memory 114 may store various records, such as event records 302 and 304. The example event record 302 can comprise a user identifier 330, an event description 332 and an event reminder time 334. The purpose of the user identifier 330 is to indicate an identity of a particular user (such as the user 102) who is associated with the event record 302. The user identifier 330 may comprise, for instance, a telephone number associated with the particular user, a numerical user identifier, an alpha-numerical user identifier, an account number, a client number and the like. For purposes of the description presented herein below, it is assumed that the user identifier 330 contains a telephone number associated with the communication device 104, which is expected to be used by the user 102.

The method for populating the event description 332 and for determining the event reminder time 334 will be described in greater detail herein below. For now, suffice it to say that the event description 332 contains an indication of the particular event that the user 102 would like to be reminded of (such as an appointment, a meeting, a task, or the like) and which has been previously provisioned by the user 102. In a specific non-limiting example, the event description 332 may contain an audio file that has been recorded by the user 102, the audio file containing: “Call Bob”, which is indicative of the user's desire to be reminded to call Bob. The event reminder time 334 may contain an indication of a time when an event reminder for the particular event indicated by the event description 332 should be conveyed to the user 102. In a specific non-limiting example, the event reminder time 334 may contain “<date><Apr. 23, 2006><time><4:55 pm>”. The event reminder time 334 can maintain information in XML format, HTML format, ASCII format or any other suitable format, as will be apparent to those of skill in the art.

The memory 114 may store a number of other event records (generally depicted at 304) which may be substantially similar to the event record 302. Each event record 304 can be maintained for a different event provisioned by the same user who has provisioned the event associated with the event record 302 (i.e., the user 102), or by a different user.

The memory 114 may further store user profile records, such as an example user profile record 306. The example user profile record 306 is created for a particular user who subscribes to the event reminder service contemplated herein, such as the user 102. The user profile record 306 comprises an indication of the identity of the user 102 associated with the user profile record 306. In the example depicted in FIG. 3, the user identifier 330 is the indication of the user's identity. The user profile record 306 further comprises a user profile 336. The purpose of the user profile 336 will be described in greater detail herein below. For the time being, suffice it to say that the user profile 336 may contain additional information associated with the user 102, such as, but not limited to, an indication of a password that can be used for authenticating the user 102, a telephone number of an alternative communication device (such as the communication device 104a), a list of pre-determined user-specified event priorities, etc.

The user profile record 306 can be generated when the user 102 subscribes to the event reminder service contemplated herein and it can be updated at a later time. How the user 102 subscribes to the event reminder service contemplated herein is immaterial and may be affected in various ways. In some non-limiting embodiments, the user 102 may call a customer service representative associated with the IVE 108 who may walk the user 102 through a registration process. In alternative non-limiting embodiments, the user 102 may subscribe to the event reminder service contemplated herein via a web portal (not depicted) accessible via the Internet, the web portal containing a web form to be completed by the user 102 as part of the registration process. Irrespective of how the registration process is implemented, the IVE 108 obtains certain data required for populating the user profile record 306 (such as a telephone number associated with the communication device 104). The IVE 108 can also provide certain parameters to the user 102 associated with the user's subscription to the event reminder service, such as, but not limited to, a password, an account number, etc. In some non-limiting embodiments, the IVE 108 can also obtain a voice sample from the user 102 to train the voice recognition function, as is known to those skilled in the art.

The memory 114 may store user profile records associated with other users, as generally depicted at 308.

Returning to FIG. 1, the IVE 108 also comprises a clock 118 connected to the aforementioned link 116. In some non-limiting embodiments, the clock 118 comprises a clock based on a global positioning system (“GPS”) device for high accuracy. In other non-limiting embodiments, the clock 118 comprises a digital clock. Generally speaking, the clock 118 can be implemented using any suitable hardware and/or software. The clock 118 is accessible by the interactive voice module 112 via the link 116. In other non-limiting embodiments, the clock 118 can reside at another entity and be accessible by the interactive voice module 112 over any suitable network (not depicted). Responsive to a query from the interactive voice module 112 (or another component of the IVE 108), the clock 118 is operable to transmit an indication of current time. In an alternative non-limiting embodiment, the clock 118 can push the indication of current time to the interactive voice module 112.

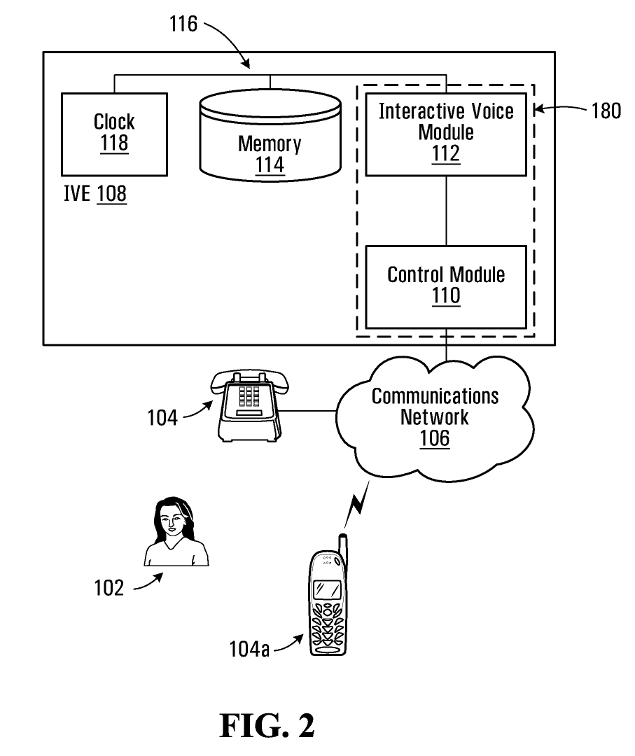

In an alternative non-limiting embodiment, the control module 110 may be part of the IVE 108, as depicted in FIG. 2. In another alternative non-limiting embodiment, the functionality of the control module 110 can be integrated with the functionality of the interactive voice module 112 into a single apparatus, as depicted by an apparatus 180 in FIG. 2. Yet in other non-limiting embodiments, the control module 110 may be omitted altogether.

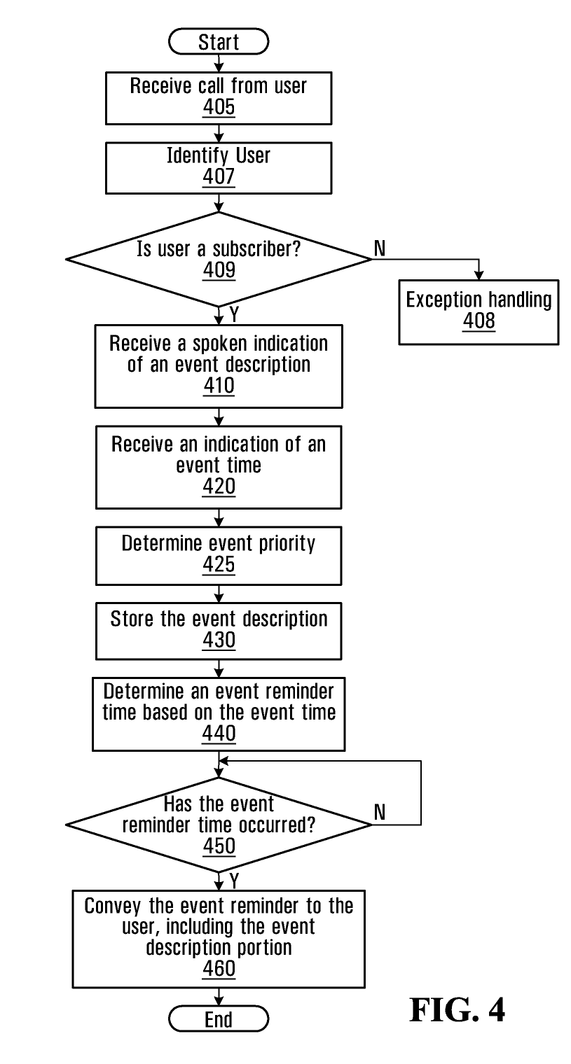

With reference to FIG. 4, operation of the system of FIG. 1 in the context of conveying an event reminder to a user will now be described. More particularly, FIG. 4 depicts a method for enabling conveyance of an event reminder according to a non-limiting embodiment of the invention. The method can be conveniently executed by the interactive voice module 112, but this is not to be construed as limiting in any respect. For the purposes of the following description, it is assumed that the user 102 is indeed a subscriber to the event reminder service contemplated herein. Accordingly, in this non-limiting embodiment, a user profile record 306 associated with the user 102 has been generated and stored in the memory 114.

### Step 405:

The method begins at step 405, where the user 102 contacts IVE 108. Specifically, the user 102 establishes what is hereinafter referred to as a “provisioning communication session” with the IVE 108. In one specific non-limiting example, the user 102 establishes the provisioning communication session by calling a number associated with the IVE 108 using the communication device 104. The number associated with the IVE 108 can be provided to the user 102 during the aforementioned registration process. Specifically, the user 102 dials the number associated with the IVE 108, which may be, but is not limited to, a local area number, a toll-free number (e.g., a “1-800” number), a premium charge number (e.g. a so-called “1-900” number), or the like.
How the call is established between the communication device 104 and the interactive voice module 112 will naturally depend on the type of the communications network 106. The call connection techniques are known to those skilled in the art and need not be discussed here at any length. In the specific non-limiting example presented herein, where the communications network 106 comprises the PSTN, the call from the communication device 104 can be first routed to the control module 110, which can perform call mediation functionality (such as analog to digital conversion and vice versa), obtain Calling Line Identification (CLID) information, initiate outgoing calls, detect and interpret DTMF signals, and the like.

### Step 407:

Next, the interactive voice module 112 identifies the user 102 of the communication device 104. In a first non-limiting example, the interactive voice module 112 may obtain a network identifier (such as but not limited to a telephone number, a SIP address and the like) of the communication device 104. The interactive voice module 112 can obtain the network identifier of the communication device 104 from the control module 110, which in turn can obtain the network identifier of the communication device 104 by examining the received Caller Line Identification (CLID) information. In other embodiments, particularly, in those where the communications network 106 is implemented in a data network adapted for supporting VoIP traffic, the network identifier of the communication device 104 can be obtained by examining the received SIP invite or any other suitable call set-up message.
In a second non-limiting example, the interactive voice module 112 may obtain an indication of the user's identity directly from the user 102. To that end, the interactive voice module 112 invokes the aforementioned interactive voice response function, which prompts the user 102 to provide the indication of the user's identity. The interactive voice module 112 prompts the user 102 to provide the indication of the user's identity that would be of the same type as the type of the user identifier stored in the user identifier 330, such as, but not limited to, a telephone number associated with the user, a numerical user identifier, an alpha-numerical user identifier, an account number, a client number, or the like.
The user 102 may provide the indication of the user's identity either by (i) keying in the information using a keypad of the communication device 104, which in turn will generate DTMF signals representative of the user's input, or (ii) produce a speech utterance representing the indication of the user's identity. In case the user 102 keys in the information, the control module 110 captures the DTMF signals produced by the communication device 104, extracts the indication of the user's identity from the captured DTMF signals and transmits the indication of the user's identity to the interactive voice module 112. In case the user 102 produces the speech utterance, the interactive voice module 112 captures the speech utterance. The interactive voice module 112 then subjects the captured speech utterance to the speech recognition function to create a textual representation of the speech utterance. Effectively, the interactive voice module 112 extracts the indication of the user's identity from the captured speech utterance.
In any case, the interactive voice module 112 becomes aware of the user's identity associated with the user 102 who has initiated the ongoing provisioning session.

### Step 409:

Next, in some non-limiting embodiments, the interactive voice module 112 can attempt to verify if the user 102 subscribes to the event reminder service contemplated herein. Equipped with the user's identity information, the interactive voice module 112 accesses the memory 114 to determine if the user 102 is a subscriber to the event reminder service. Specifically, if the interactive voice module 112 is successful in locating a user profile record which contains a user identifier 330 that contains data matching the user's identity information, the interactive voice module 112 determines that the user 102 is indeed a subscriber to the event reminder service. In the specific example being discussed herein, the interactive voice module 112 will determine that the user 102 is a subscriber to the event reminder service, if the user identifier 330 of the user profile record 306 contains a telephone number that matches the telephone number associated with the communication device 104 that is expected to be used by the user 102. If the interactive voice module 112 is successful in determining that the user 102 is a subscriber to the event reminder service (i.e. the “Yes” branch of step 409), the interactive voice module 112 proceeds to step 410.
However, if the interactive voice module 112 fails to locate the user profile record associated with the user 102 (i.e. the “No” branch of the step 409), the interactive voice module 112 can execute an exception handling function 408, such as but not limited to advising the user 102 that he or she does not subscribe to the event reminder service, forward the call to a customer service representative to walk the user 102 through the registration process, etc.
In some non-limiting embodiments, the interactive voice module 112 may further prompt the user 102 to provide a password. In response to such prompting, the user 102 can provide his or her password in substantially the same manner as described above in respect of the user 102 providing an indication of the user's identity. For example, the user 102 can provide the password in two ways:
   (i) key in information using the communication device 104; or
   (ii) produce a speech utterance representative of the indication of the event time.
In these embodiments, the interactive voice module 112 is operable to search the memory 114 to determine (i) if a user profile record (such as the user profile record 306) matching the user's identity information has been created; and if yes (ii) whether the password provided by the user 102 matches the password maintained in the user profile 336.

### Step 410:

Once the interactive voice module 112 authenticates the user 102, the interactive voice module 112 invokes the interactive voice response function, which prompts the user 102 to provide a spoken indication of an event description. The user 102 produces a speech utterance containing an indication of the event description. In this specific example, the user 102 utters “Call Bob”. The interactive voice module 112 captures the speech utterance and creates an audio file according to any suitable audio format, such as, but not limited, to a WAV, AVR, MP3, WMA, VQF, AIFF, or the like.
In an alternative non-limiting example, the speech utterance can be recorded by the communication device 104 and the communication device 104 can transmit the recorded speech utterance to the interactive voice module 112. This is particular true for embodiments, whereby the communication device 104 is implemented in a VoIP telephone which is equipped with a local speech recognition module.

### Step 420:

At step 420, the interactive voice module 112 receives an indication of an event time. Generally speaking, the event time represents a time associated with the event for which the user 102 provisions the event reminder. In the example being discussed herein, the event time (i.e. the time to call Bob) is 5:00 pm on Apr. 23, 2006.
To that end, the interactive voice module 112 may invoke the interactive voice response function, which prompts the user 102 to provide an indication of the event time. For example, the user 102 can provide the indication of the event time in two ways:
   (i) key in information using the communication device 104; or
   (ii) produce a speech utterance representative of the indication of the event time.
In case the user 102 keys in the information, the interactive voice module 112 invokes the interactive voice response function, which may prompt the user 102 to provide an indication of a time, a date, a month and a year associated with the event in a manner known in the art. To take an example of the month, the interactive voice module 112 can prompt the user 102 to provide the indication of the month by presenting the user 102 with several choices, such as “press 01 for January”, “press 02 for February”, “press 03 for March” and so on.
The control module 110 captures the DTMF signals produced by the communication device 104, extracts the indication of the event time from the captured DTMF signals and transmits the indication of the event time to the interactive voice module 112.
In case the user 102 produces the speech utterance, the interactive voice module 112 captures the speech utterance. The interactive voice module 112 then subjects the captured speech utterance to the speech recognition function to create a textual representation of the speech utterance. In any case, the interactive voice module 112 becomes aware of the event time.

### Step 425:

In some non-limiting embodiments of the present invention, the user 102 can also provide an indication of an event priority. Specifically, at step 425, which in some non-limiting embodiments can be part of step 420 or step 410, the interactive voice module 112 may invoke the interactive voice response function, which prompts the user 102 to provide the indication of the event priority. For example, the user 102 can provide the indication of the event priority in two ways:
   (i) key in information using the communication device 104; or
   (ii) produce a speech utterance representative of the indication of the event time.
Irrespective of how the user 102 provides the indication of the event priority, the interactive voice module 112 processes the received indication in substantially the same manner as described above in reference to provision of the indication of the event time.
It is contemplated that in some non-limiting embodiments, the indication of the event priority can comprise one of a pre-determined priority levels (such as but not limited to Low and/or High). In other non-limiting embodiments of the present invention, the interactive voice module 112 can present the user 102 a list of pre-determined choices associated with the event priority stored in the aforementioned user profile 336.

### Step 430:

At this step, the interactive voice module 112 stores the event description received at step 410. Specifically, the interactive voice module 112 creates the aforementioned event record 302. Firstly, the interactive voice module 112 populates the user identifier 330 with the indication of the user's identity determined at step 410. Secondly, the interactive voice module 112 populates the event description 332. Specifically, the interactive voice module 112 stores the audio file created at step 410 in the event description 332. Effectively, the interactive voice module 112 has stored the spoken event description in association with the user who has provisioned the event description (i.e. the user 102).

### Step 440:

At this step, the interactive voice module 112 determines what is hereinafter referred to as an “event reminder time” based on the event time captured at step 420. In one non-limiting example, the interactive voice module 112 determines a time when an event reminder should be conveyed to the user 102. Several alternatives for determining the event reminder time are envisioned:

Determination Based on a System-Wide Default Time Interval:
In this non-limiting scenario, the interactive voice module 112 determines the event reminder time by subtracting a pre-defined time interval from the event time captured at step 420. The pre-defined time interval can be 5 minutes, 1 hour, 1 month, or any other conceivable time interval. In this non-limiting scenario, a default pre-defined time interval may be applied for determining the event reminder time for event reminders provisioned by all users (including the user 102) who subscribe to the event reminder service contemplated herein. In an illustrative example not to be considered limiting, the system-wide default time interval can be 5 minutes. Accordingly, the interactive voice module 112 determines the event reminder time to be <date><Apr. 23, 2006><time><4:45 pm> which represents an instant of time which occurs 5 minutes before the event time associated with the reminder “Call Bob”.

Determination Based on an Indication of a Default Time Interval Extracted from a User Profile:
In this non-limiting scenario, as part of the registration process, the user 102 provides the indication of the default time interval to be used for event reminder time determination, which is stored in the aforementioned user profile 336 of the user profile record 306. The interactive voice module 112 extracts the default time interval from the user profile 336 and subtracts this default time interval from the event time to derive the event reminder time.

Determination Based on an Indication of a Time Interval Obtained from the User:
In this non-limiting scenario, the interactive voice module 112 obtains the indication of the time interval to be used for determining the event reminder time from the user 112 for each particular event during the provisioning communication session. Specifically, the interactive voice module 112 invokes an interactive voice response function, which prompts the user 102 to provide the indication of the time interval, which the user 102 can provide in the same manner as described above in association with step 420.
Once the interactive voice module 112 receives the indication of the time interval from the user 102, the interactive voice module 112 determines the event reminder time by subtracting the obtained time interval from the event time. Alternatively, the interactive voice module 112 can store the received indication of the time interval and perform determination at a later time.

Optional Enhancement:
As a possible enhancement to the above-described scenarios, the interactive voice module 112 can determine more than one event reminder time. Take for example the above-referenced scenario based on the system-wide default time interval. In this scenario, the interactive voice module 112 may maintain two default periods of time to be used for determination of the event reminder time, such as 30 minutes and 5 minutes. Accordingly, the interactive voice module 112 can determine two event reminder times—one 30 minutes prior to the event time and another one 5 minutes prior to the event time. In this scenario, the event reminder will be conveyed twice to the user 102, namely 30 minutes before the event time and 5 minutes before the event time.
Irrespective of how the event reminder time is determined, the determined event reminder time is stored in the event record 302 and, specifically, in the event reminder time 334. In some embodiments of the present invention, the event reminder time can be stored according to XML format, such as:
   <event reminder time><date><Apr. 23, 2006><time><4:55 pm>
Any other suitable format can be used for storing the event reminder time in the event reminder time 334.
In some non-limiting embodiments of the present invention, and particularly in embodiments where the user 102 has provided the indication of the event priority, the interactive voice module 112 also stores the indication of the event priority (such as high or low, for example) in the event record 302. In an example embodiment, the interactive module 112 can store the indication of the event priority in the event reminder time 334 in any suitable format, such as but not limited to:
   <event priority><high>
Naturally, the interactive voice module 112 can store the indication of the event priority in a dedicated field (not depicted) or any other suitable field of the event record 302.
Accordingly, by performing steps 405 through to 440 above, the interactive voice module 112 populates the event record 302 which contains an event description (i.e. data maintained in the event description 332) and an event reminder time (i.e. data maintained in the event reminder time 334).

### Step 450:

At this step, the interactive voice module 112 verifies if a particular event reminder time has occurred. Specifically, the interactive voice module 112 consults the aforementioned clock 118 to determine the current time. In response to a query from the interactive voice module 112, the clock 118 transmits an indication of the current time to the interactive voice module 112 via the link 116. The interactive voice module 112 then compares the current time with each of the event reminder times (such as the event reminder time 334) to determine if any of the event reminder times (such as the event reminder time 334) matches the current time.
If no match is determined (i.e. the “No” branch of step 450), the interactive voice module 112 returns to step 450 where it repeats verifying if any event reminder times has occurred. If, on the other hand, a match has been determined (i.e. the “Yes” branch of step 450), the interactive voice module 112 proceeds to step 460. For purposes of the discussion presented herein below, assume that the clock 118 has returned the indication of the current time containing <date><Apr. 23, 2006><time><4:45 pm>. Accordingly, the interactive voice module 112 determines that the event reminder time 334 has occurred and proceeds to step 460.
In alternative non-limiting embodiments of the present invention, the step 450 can be implemented by the memory 114 receiving the indication of the current time from the clock 118. Once the memory 114 receives the indication of time from the clock 118, it then compares the current time with each of the event reminder times (such as the event reminder time 334) to determine if any of the event reminder times (such as the event reminder time 334) matches the current time.

### Step 460:

At step 460, the interactive voice module 112 conveys the event reminder to the user 102. Several non-limiting scenarios for conveying the event reminder are envisioned:

Scenario 1:
It will be recalled that the user identifier 330 may contain a telephone number associated with the communication device 104. In this non-limiting scenario, the interactive voice module 112 accesses the event record 302 (based on the fact that the event reminder time 334 has occurred as has been previously determined at step 450) and retrieves the content of the user identifier 330, which contains the telephone number of the communication device 104. The interactive voice module 112 attempts to establish a reminder communication session with the user 102 by dialling the telephone number associated with the communication device 104. In an alternative embodiment, the interactive voice module 112 may instruct the control module 110 to establish the reminder communication session with the communication device 104. In such an embodiment, the interactive voice module 112 transmits the telephone number of the communication device 104 to the control module 110, which in turn originates an outgoing call to the communication device 104.
If the reminder communication session can not be established (for example, the user 102 does not answer the call, the line is busy or the call terminates to a voice mail), the interactive voice module 112 can invoke an exception handling function, which can be, but is not limited to, ignoring an event reminder, attempting to establish the reminder communication session after a pre-defined time interval (such as 1 minute, 2 minutes, 5 minutes, 10 minutes, etc.), repeating attempts to establish the reminder communication session until successful, and the like.
Assume that the interactive voice module 112 has successfully established the reminder communication session with the communication device 104 (i.e. the user 102 has answered the call). Optionally, the interactive voice module 112 may authenticate the user 102 prior to conveying the event reminder, for example by soliciting a password in a manner similar to that previously described in relation to step 410.
The interactive voice module 112 then retrieves the audio file stored in the event description 332 and plays the content of the audio file to the user 102 via the event reminder communication session. Accordingly, the user 102 receives an event reminder, which in the example described herein contains “Call Bob” which has been previously recorded by the user 102 at step 410.

Scenario 2:
In this non-limiting scenario, the event reminder is conveyed to the secondary communication device 104a also associated with the user 102. It will be recalled that the user profile 336 may maintain a network identifier of the communication device 104a. The network identifier of the secondary communication device 104a can be obtained from the user 102 during the aforementioned registration process and stored in the user profile 336. In these embodiments, when the interactive voice module 112 obtains the event description at step 410, the interactive voice module 112 can further prompt the user 102 to provide an indication of whether the user 102 wants the event reminder to be conveyed to the communication device 104 (the network identifier of which is stored in the user identifier 330) or to the secondary communication device 104a (the network identifier of which is stored in the user profile 336).
Alternatively, rather than obtaining the network identifier of the secondary communication device 104a during the registration process, the interactive voice module 112 can prompt the user 102 at step 420 to provide an indication of the network identifier of the communication device 104a, which, once received from the user 102, is stored in the user profile 336.
Responsive to the event reminder time maintained in the event reminder time 334 occurring, as determined at step 450, the interactive voice module 112 consults the user profile 336 to retrieve the network identifier of the communication device 104a. Equipped with this information, the interactive voice module 112 conveys the event reminder to the secondary communication device 104a in substantially the same fashion as described above in relation to Scenario 1. Effectively, the user 102 has received an event reminder at the communication device 104a.
It should be noted that this scenario can be used in reverse. That is, the user 102 can use the secondary communication device 104a to provision an event reminder that is to be conveyed to the communication device 104.

Scenario 3:
In this non-limiting scenario, the interactive voice module 112 conveys the event reminder to the secondary communication device 104a in substantially the same manner as discussed above in relation to Scenario 2, except for the specific differences discussed below.
In this scenario, the interactive voice module 112 subjects the audio file containing the indication of the event description stored in the event description 332 to the speech recognition function to derive a textual representation of the event description. The interactive voice module 112 then conveys the event reminder to the secondary communication device 104a by sending an electronic message (such as, but not limited to, an SMS, an e-mail, or the like) containing the textual representation of the event description to the secondary communication device 104a for displaying the textual representation of the event description to the user 102.
In an alternative implementation of this embodiment, the interactive voice module 112 can subject the speech utterance received at step 410 to the speech recognition function before executing step 430 described above. In this embodiment, the interactive voice module 112 stores a file that contains the textual representation of the event description.

Scenario 4:
Similarly to Scenario 3 above, in this non-limiting scenario, the interactive voice module 112 also creates a textual representation of the event description. The interactive voice module 112 transmits a file containing the textual representation of the event description to the communication device 104a. In these embodiments, the secondary communication device 104a can execute local software which maintains a schedule, i.e. a local scheduling application such as Agendus Professional V9.01 for Palm 3.5 to Palm 5.x. In these embodiments, the file containing the textual representation conveyed to the secondary communication device 104a is instrumental in causing the local software which maintains the schedule to be updated with the event reminder. This scenario is particularly useful when the user 102 does not currently have access to the communication device 104a, but nevertheless would like to update the schedule maintained by the local software of the secondary communication device 104a with the event reminder. In some embodiments of the present invention, in this scenario, the local scheduling application can perform the determining the event reminder time and conveying the event reminder to the user 102 at the appropriate event reminder time.

Scenario 5
In this non-limiting scenario, the interactive voice module 112 conveys the event reminder in substantially the same manner as described above in respect to Scenario 1. However, in this non-limiting scenario, the interactive voice module 112 further solicits the user 102 to provide a so-called disposition instruction. For example, the user 102 can provide the disposition instruction in two ways:
   (i) key in information using the communication device 104; or
   (ii) produce a speech utterance representative of the indication of the event time.
Several non-limiting types of the disposition instructions are contemplated herein. For example, the user 102 may provide a disposition instruction indicative of the user 102 accepting the event reminder. In this example, the event record 302 associated with the particular event can be deleted from the memory 114.
By means of another non-limiting example, the user 102 may provide a disposition instruction indicative of the user's desire to “snooze” the event reminder. This type of a disposition instruction will indicate to the interactive voice module 112 to repeat the event reminder conveyance after a time interval, such as 5 minutes, 15 minutes, 1 hour, 24 hours or any other conceivable variant thereof.
Naturally, other types of disposition instructions are also possible.

Scenario 6
In this non-limiting scenario, the interactive voice module 112 retrieves the indication of the event priority from the event record (such as the event record 302). How the interactive voice module 112 treats the event reminder based on the retrieved event priority is not particularly limited and several non-limiting examples are presented herein below. It should be noted that these examples should not be construed as limiting in any sense.

High Priority Event Reminder
In case that the retrieved indication of the event priority indicates that the event has a high priority, the interactive voice module 112 can take one or more of the below-listed actions:
(i) when conveying the event reminder to the user 102, the interactive voice module 112 can add an indication that the event has high priority. For example, the interactive voice module 112 can play a standard message (such as “THE FOLLOWING MESSAGE HAS A HIGH PRIORITY” or any conceivable variant thereof) before conveying the event description. Alternatively, the interactive voice module 112 can send an instant message in a different colour if instant messaging is used to covey the event reminder. In yet another alternative, the interactive voice module 112 can add an “IMPORTANT” tag to an electronic message, if the electronic message is used for conveying the event reminder.
(ii) convey the event reminder to the communication device 104 and in case that the receipt of the event reminder is not confirmed by way of a receipt of a suitable disposition instruction (as described above in reference to scenario 5), attempt to convey the event reminder to the communication device 104a.
(iii) convey the event reminder via more than one communication channel, for example combining the above Scenario 1 (conveying the event reminder to the communication device 104) and the above Scenario 3 (conveying the event reminder to the secondary communication device 104a as an electronic message).
(iv) if a voice mail condition is detected when conveying the event reminder, attempt to convey the event reminder until the receipt of an event reminder is confirmed by the user 102 (as described above in reference to Scenario 5). Stated differently, if the event priority is high, the interactive voice module 112 will not leave a voice mail message containing the event reminder.

Low Priority Event Reminder
In case that the retrieved indication of the event priority indicates that the event has a low priority, the interactive voice module 112 can take one or more of the below-listed actions:
(i) even if a voice mail condition is detected when conveying the event reminder, the interactive voice module 112 plays the event description. Effectively, the interactive voice module 112 “leaves a voicemail message” containing the event description destined to the user 102.
(ii) if the receipt of the event reminder is not confirmed by way of a receipt of a suitable disposition instruction (as described above in reference to Scenario 5), the interactive voice module 112 can snooze the conveyance of the event reminder.
Other alternatives for treating event priority are also possible.

### Other Scenarios:

Yet other alternative scenarios for conveying the event reminders will become apparent to those skilled in the art have benefit of the teachings of this invention.

Once a particular event reminder is conveyed to the user 102, the interactive voice module 112 can delete from the memory 114 the event record associated with the particular event reminder (such as the event record 302). Alternatively, the interactive voice module 112 can archive the event record 302 to an archive portion (not depicted) of the memory 114.

Although, the foregoing description has primarily described the step of determining the event reminder time based on an instance of time which occurs at a time interval prior to the event time, it should be understood that other types of event reminder time are envisioned. For example, the event reminder time may comprise an instant of time that coincides in time with the event time. In another example, the event reminder time may comprise an instant of time that occurs later in time than the event time. Yet as another example, the event reminder time may comprise an indication of date and time that coincide with an external event, such as the user's birthday, certain days of the week, or the like.

Also, although the foregoing description has used an example of the user 102 provisioning an event reminder by establishing the reminder provisioning session so that the event reminder is eventually conveyed to the user 102 (either using the communication device 104 or the communication device 104a), it within the scope of this invention for the user 102 to provision an event reminder that is to be conveyed to another user using a communication device associated with that other user.

In addition, although the registration process has been described in terms of the user 102 interacting with a customer service representative or a web portal, the registration process can also be implemented so that the user 102 interacts with the interactive voice module 112 in substantially the same way as described above in relation to the provisioning of the event reminder. It should thus be clear that the user 102 can use the event reminder service contemplated herein, even if the communication device 104 employed by the user 102 is a less sophisticated device, such as a legacy POTS phone or even a rotary phone.

Persons skilled in the art will appreciate that there are yet more alternative implementations and modifications possible for implementing the present invention, and that the above implementations and examples are only illustrations of one or more non-limiting embodiments. The scope of the invention, therefore, is only to be limited by the claims appended hereto.

What is claimed is:

1. A method for conveying an event reminder associated with an event, the method comprising:
establishing a provisioning communication session with a user;
during said provisioning communication session, receiving a spoken indication of an event description from the user and receiving an indication of an event time;
storing said event description in association with the user in a memory;
determining an event reminder time based on said event time;
responsive to an occurrence of said event reminder time, conveying the event reminder to the user; the event reminder comprising at least said event description.

2. The method as defined in claim 1, further comprising determining if said event reminder time has occurred.

3. The method as defined in claim 2, wherein said determining if said event reminder time has occurred comprises continuously monitoring if said event reminder time has occurred.

4. The method as defined in claim 2, wherein said determining if said event reminder time has occurred comprises:
receiving an indication of a current time from a clock;
comparing the current time with said event reminder time.

5. The method as defined in claim 4, further comprising:
determining that said event reminder time has occurred, if said comparing renders a positive outcome.

6. The method as defined in claim 1, wherein said receiving an indication of an event time comprises receiving a spoken indication of said event time from the user; and wherein said determining comprises:
subjecting said spoken indication of said event time to a speech recognition function to derive said event time.

7. The method as defined in claim 6, wherein said determining further comprises:
calculating the event reminder time by subtracting a time interval from said event time.

8. The method as defined in claim 7, further comprising obtaining said time interval; wherein said obtaining said time interval comprises one of:
prompting the user to provide an indication of said time interval;
retrieving said time interval from a user profile stored in the memory;
retrieving a default time interval from the memory.

9. The method as defined in claim 1, wherein said receiving an indication of an event time comprises receiving from the user at least one DTMF signal representative of said indication of an event time; and wherein said determining comprises:
extracting said event time from said received at least one DTMF signal;
calculating the event reminder time by subtracting a time interval from said event time.

10. The method as defined in claim 9, further comprising obtaining said time interval; wherein said obtaining said time interval comprises one of:
prompting the user to provide an indication of said time interval;
retrieving said time interval from a user profile stored in the memory;
retrieving a default time interval from the memory.

11. The method as defined in claim 1, wherein the provisioning communication session is a telephony session.

12. The method as defined in claim 1, wherein said establishing a provisioning communication session comprises receiving a call from the user at a telephone number associated with an interactive voice entity.

13. The method as defined in claim 12, further comprising authenticating the user; wherein said receiving a spoken indication of an event is executed only upon said authenticating rendering a positive outcome.

14. The method as defined in claim 13, wherein said identifying comprises:
determining a network identifier of a communication device employed by the user to establish said call;
accessing the memory comprising at least one user profile record to verify if the at least one user profile record contains a user identifier that matches said network identifier.

15. The method as defined in claim 13, wherein said identifying comprises:
receiving an indication of a user's identity from the user;
accessing the memory comprising at least one user profile record to verify if the at least one user profile record contains a user identifier that matches said indication of a user's identity.

16. The method as defined in claim 15, wherein said receiving an indication of a user's identity comprises one of:
receiving a speech utterance indicative of said indication of a user's identity; and
receiving at least one DTMF signal representative of said indication of a user's identity.

17. The method as defined in claim 15, wherein said receiving an indication of a user's identity comprises said receiving a speech utterance indicative of said indication of a user's identity; and wherein said authenticating further comprises:
subjecting said speech utterance to a speech recognition function to derive said indication of a user's identity.

18. The method as defined in claim 13, further comprising authenticating the user.

19. The method as defined in claim 18, wherein said authenticating comprises receiving an indication of a password.

20. The method as defined in claim 19, wherein said receiving an indication of a password comprises one of:
receiving a speech utterance indicative of said indication of a password; and
receiving at least one DTMF signal representative of said indication of a password.

21. The method as defined in claim 1, further comprising:
prompting the user to provide said spoken indication of an event description.

22. The method as defined in claim 1, further comprising:
prompting the user to provide said indication of an event time.

23. The method as defined in claim 1, wherein said receiving an indication of an event time comprises:
subjecting said spoken indication of an event description to a speech recognition function in an attempt to determine presence of the indication of said event time within said spoken indication of an event description.

24. The method as defined in claim 1, further comprising receiving an indication of an event priority.

25. The method as defined in claim 1, further comprising receiving a disposition instruction from the user.

26. The method as defined in claim 25, wherein said disposition instruction comprises a confirmation instruction, the method further comprising terminating a communication session used for said conveying.

27. The method as defined in claim 25, wherein said receiving a disposition instruction comprises failing to receive a receipt confirmation; and wherein the method further comprises attempting to convey the event reminder to the user after a period of time.

28. The method as defined in claim 1, wherein said storing comprises generating an audio file comprising said event description.

29. The method as defined in claim 28, wherein said storing further comprises uploading said audio file and said event reminder time in the memory.

30. The method as defined in claim 29, further comprising assigning an identifier to said audio file, said identifier being indicative of an identity of the user.

31. The method of claim 28, wherein said conveying the event reminder to the user comprises playing said audio file to the user.

32. The method as defined in claim 1, further comprising:
receiving an identifier of a terminating endpoint to which said event reminder is to be conveyed.

33. The method as defined in claim 32, wherein said receiving an identifier of a terminating endpoint comprises:
prompting the user to provide said identifier of a terminating endpoint;
receiving an indication of said identifier of a terminating endpoint from the user.

34. The method as defined in claim 32, wherein said receiving an identifier of a terminating endpoint comprises retrieving said identifier of a terminating endpoint from a user profile stored in the memory.

35. The method as defined in claim 32, wherein said receiving an identifier of a terminating endpoint comprises determining a network identifier of a communication device employed by the user to establish a provisioning communication session to provide said spoken indication of an event.

36. The method as defined in claim 32, wherein said conveying the event reminder to the user comprises establishing a reminder communication session with the terminating endpoint.

37. The method as defined in claim 36, said identifier of a terminating endpoint comprising a telephone number, wherein said establishing a reminder communication session with the terminating endpoint comprises calling said telephone number.

38. The method as defined in claim 37, further comprising authenticating the user via said reminder communication session before said conveying is executed.

39. The method as defined in claim 32, wherein
storing said event description comprises subjecting said spoken indication of an event description to a speech recognition function to derive a textual representation of said event description; and wherein
said conveying the event reminder to the user comprises sending an electronic message to the terminating endpoint; said electronic message comprising said textual representation.

40. The method as defined in claim 39, said terminating endpoint comprising a wireless communication device, wherein said sending an electronic message comprises sending an SMS message to said wireless communication device.

41. The method as defined in claim 39, wherein said terminating endpoint comprising a VoIP telephone, wherein said sending an electronic message comprises sending an instant message to said wireless communication device.

42. The method as defined in claim 39, wherein said sending an electronic message comprises sending an e-mail to the terminating endpoint.

43. The method as defined in claim 1, wherein said conveying comprises:
subjecting said spoken indication of an event description to a speech recognition function to derive a textual representation of said event description; and
transmitting said textual representation to a communication device associated with the user, the communication device hosting a local scheduling application; and wherein
said textual representation enables updating of the local scheduling application with said event reminder.

44. The method as defined in claim 1, wherein said method further comprises prior to said conveying:
subjecting said spoken indication of an event description to a speech recognition function to derive a textual representation of said event description;
transmitting said textual representation and said event reminder time to a communication device associated with the user, the communication device hosting a local scheduling application; and wherein
said conveying is performed by the local scheduling application.

45. The method as defined in claim 44, wherein said determining is also performed by the local scheduling application.

46. An apparatus for conveying an event reminder comprising:
means for establishing a provisioning communication session with a user;
means for receiving a spoken indication of an event description from the user; during the provisioning communication session
means for receiving an indication of an event time during the provisioning communication session;
means for storing said event description in association with the user in a memory;
means for determining an event reminder time based on said event description;
means for conveying the event reminder to the user; the event reminder comprising at least said event description; said means for conveying being responsive to an occurrence of said event reminder time.

47. A system for conveying an event reminder comprising:
an interactive voice entity comprising:
an input operable to:
receive a spoken indication of an event description from a user of a communication device;
receive an indication of an event time;
a memory operable to store said event description in association with the user in the memory;
a processing entity operable to determine an event reminder time based on said event description;
an output operable to convey the event reminder to the user responsive to an occurrence of said event reminder time; the event reminder comprising at least said event description.

48. The system as defined in claim 47, wherein said processing entity is further operable to establish a reminder communication session with the communication device, the event reminder being conveyed over the communication session.

49. The system as defined in claim 47, wherein the input is operable to receive an indication of a network identifier of the communication device; and wherein the processing entity is operable to establish a reminder communication session with the communication device to convey the event reminder.

50. The system as defined in claim 47, wherein said processing entity is further operable to determine if said event reminder time has occurred.

51. The system as defined in claim 50, further comprising a clock, wherein to determine if said event reminder time has occurred, the processing entity is operable to:
receive an indication of time from the clock;
compare the indication of time with said event reminder time.

52. A method for provisioning an event reminder, the method comprising:
establishing a reminder provisioning communication session with a server, the server being operable to execute a speech recognition function;
during the reminder provisioning communication session, providing a spoken indication of an event description; said spoken indication of an event description for enabling the server to store said event description;
during the reminder provisioning communication session, providing an event time; said event time for enabling the server to determine an event reminder time;
at a time no earlier than said event reminder time, receiving the event reminder; the event reminder comprising at least said event description.

53. The method as defined in claim 52, further comprising:
performing a registration process prior to said establishing a provisioning communication session.

54. The method as defined in claim 53, wherein said performing a registration process comprises:
establishing a registration communication session with the server to indicate a desire to subscribe to an event reminder service;
receiving from the server at least one of: an account number, a telephone number associated with the server for establishing the provisioning communication session and a password.

55. The method as defined in claim 52, wherein said receiving the event reminder comprises:
receiving an electronic message.

56. The method as defined in claim 55, wherein said electronic message comprises at least one of:
a short text message, an instant message and an e-mail.

57. The method as defined in claim 52, wherein said receiving the event reminder occurs at a communication device operable to execute a local scheduling application, the event reminder allowing updating of the local scheduling application.

58. A method for handling an event reminder associated with an event, the method comprising:
receiving a spoken indication of an event description from a user;
receiving a spoken indication of an event time from the user;
subjecting said spoken indication of said event time to a speech recognition function to derive said event time; and
storing said event description as an audio file attached to a time slot in a scheduling application, the time slot corresponding to said event time.
